(19) United States
(12) Patent Application Publication
(10) Pub. No.: US 2012/0078803 A1
(43) Pub. Date: Mar. 29, 2012

(54) System, Method, And Computer Readable Media For Facilitating Employment Through The Exchange Of Job Openings And/Or Job Related Information Between Job Seekers

(75) Inventor: Andrew MacArthur, New York, NY (US)

(73) Assignee: Andrew MacArthur, New York, NY (US)

(21) Appl. No.: 13/169,028

(22) Filed: Jun. 27, 2011

(51) Int. Cl. G06Q 99/00

(52) U.S. Cl. 705/319

(57) ABSTRACT

Embodiments disclosed herein provide system, method and computer readable media for facilitating job seekers to share job openings with other job seekers. One or more job openings from a first job seeker are received and displayed, and actions are received from a second job seeker for the one or more job openings related to the first job seeker. Also disclosed are dynamic groups which are groups of job seekers automatically created to assist with job searching. Additionally disclosed are people and/or entities interacting across various countries and states and job seekers being shown one or more ways to obtain a future type of job. Further, dynamic networks are disclosed where a networker and networkee are arrange based on a variety of criteria.

### COPYRIGHT NOTICE

A portion of the disclosure of this patent document contains material which is subject to copyright protection. The copyright owner, Andrew P. MacArthur, has no objection to the facsimile reproduction by anyone of the patent document or the patent disclosure, as it appears in the Patent and Trademark Office patent file or records, but otherwise reserves all copyright rights whatsoever. The following notice applies to this entire document: Copyright© 2011, Andrew P. MacArthur. All rights reserved.

### FIELD OF THE INVENTION

The innovative invention relates to sharing job openings and job related information between job seekers to facilitate employment faster. It also relates to dynamically forming groups and/or networks which will further facilitate employment.

### BACKGROUND OF THE INVENTION

Finding a job has never been more critical than the present considering the economic environment along with the costs associated with living. Normally, to find a job opening an employer provides job openings on its website and/or job websites and receives applications from job seekers. All available jobs are not provided on these websites as some employers do not provide openings and instead rely on other mechanisms to obtain suitable candidates. Some mechanisms include recruiters and the like to find job seekers.

But some may not know about the job websites and/or work with recruiters. As a result, obtaining a job is sometimes not based on the skill of the job seeker, but which job seeker has knowledge (and/or connections) about the job opening. For example, a given job opening may have 100 suitable job seekers in the market based on each of the job seeker's credentials. May be only 25 of these actually know about the job opening and thereby apply, meaning 75 other, capable job seekers do not apply.

The forgoing job websites and mechanisms fail to recognize that many job seekers themselves have information on available jobs as they are conducting and/or have already conducted a focused search to obtain a job. Also, it would be advantageous or beneficial, in direct contrast to the norm, if job seekers are encouraged to work together to find a job rather than having a competing mentality. Accordingly, there is a need for job seekers to share job openings and other information with other job seekers and thus enable them to find jobs. One of the worst feelings of any job seeker is not even having a chance to apply for a job opening—the disclosure herein provides him or her with that opportunity.

### SUMMARY OF THE INVENTION

System, method, and computer readable media are disclosed for facilitating employment through the exchange of job openings and/or job related information between job seekers. In one embodiment, a computerized method for facilitating employment comprising receiving using an electronic device from a first job seeker one or more job openings; displaying using an electronic device the first job seeker one or more job openings; and receiving using an electronic device an action from a second job seeker related to the first job seeker one or more job openings. In another embodiment, the first job seeker one or more job openings comprises job openings that the first job seeker was rejected. In another embodiment, the method further comprises submitting using an electronic device from the second job seeker one or more applications for the first job seeker one or more job openings.

In another embodiment, the method further comprises analyzing information related to the second job seeker; and providing suggestions to a third job seeker based on the analyzed information related to the second job seeker. In another embodiment, the method further comprises awarding benefits to the first job seeker for the second job seeker becoming employed based on the action from the second job seeker related to the first job seeker one or more job openings. The benefits in one embodiment comprise at least one of money, points, job openings, or job leads.

According to one embodiment, the method further comprises exchanging the first job seeker one or more job openings with a third job seeker one or more job openings. In another embodiment, the method further comprises receiving a communication from the second job seeker that the first job seeker one or more job openings were filled by the second job seeker. In another embodiment, the method further comprises receiving information from a third job seeker on the first job seeker one or more job openings, wherein the third job seeker is provided benefits for providing the further information. In another embodiment, displaying using an electronic device the first job seeker one or more job openings comprises one or more job openings that are verified as available.

According to one embodiment, the method further comprising receiving from a third job seeker one or more job openings. In another embodiment, displaying using an electronic device the first job seeker one or more job openings comprises at two of grade point average cutoff, educational requirements, work experience requirements, number of applications submitted for the one or more job openings, or likelihood of success by the second job seeker. In another embodiment, receiving using an electronic device an action from a second job seeker related to the first job seeker one or more job openings comprises viewing an employer associated with the first job seeker one or more job openings; and displaying employer characteristics comprising at least one of: employer ranking, employee school factor, employer revenue, insider viewpoints, turnover of employees over a period of time, or securities and exchange commission filings.

According to one embodiment, the method further comprises creating one or more groups based on a profile of the second job seeker, wherein the group is related to at least one of educational background, work experience, and job type sought. In another embodiment, the method further comprises holding a practice interview session comprising one or more job seekers associated with the one or more groups; recording the interview session; and providing feedback to the one or more job seekers. In another embodiment, the method further comprises receiving a past interview question and an answer from a third job seeker; and receiving feedback from a fourth job seeker. In another embodiment, the method further comprises receiving a question from a third job seeker; and receiving an answer to the question from one or more third-parties. In another embodiment, the method further comprises receiving job information from a third job seeker; determining one or more requirements for the job information; and providing one or more ways to achieve the job information based on the one or more requirements.

According to one embodiment, a system comprises at least one processing device coupled to at least one client device over a network, the at least processing device operable at least to: receive from a first job seeker one or more job openings; display the first job seeker one or more job openings; and receive an action from a second job seeker related to the first job seeker one or more job openings.

According to one embodiment, there is a non-transitory computer readable media having computer readable program code embodied therein, the computer readable program code when executed by a processing device causes the processing device to perform a method comprising: receiving from a first job seeker one or more job openings; displaying the first job seeker one or more job openings; and receiving an action from a second job seeker related to the first job seeker one or more job openings.

### BRIEF DESCRIPTION OF THE DRAWINGS

The figures of the accompanying drawings which are meant to be examples and not limiting:

FIG. 1, according to one embodiment, presents a system for sharing job openings;

FIG. 2, according to one embodiment, presents a block diagram illustrating the sharing of one or more job openings;

FIG. 3, according to one embodiment, presents a system showing one or more job openings;

FIG. 4, according to one embodiment, presents a system showing employer related information for one or more job openings;

FIG. 5, according to one embodiment, presents a system which shows people and/or entities interacting across various countries and states;

FIG. 6, according to one embodiment, presents a block diagram to create groups;

FIG. 7, according to one embodiment, presents a system to provide a top job searching document;

FIG. 8, according to one embodiment, presents a system to show a projection of a career;

FIG. 9, according to one embodiment, presents a system to show how a second job seeker could step into the shoes of a first job seeker; and

FIG. 10, according to one embodiment, presents a block diagram for a networking method.

### DETAILED DESCRIPTION OF THE EMBODIMENTS

In the following description, reference is made to the accompanying drawings to illustrate sample embodiments. Many other embodiments may be utilized, and changes may be made to the sample embodiments without departing from the scope of the claimed invention. Further, embodiments may exist with single, discrete components, and alternative embodiments exist wherein the illustrated devices may be integrated and/or distributed across multiple hardware devices. Moreover, parts of each embodiment may be used with whole and/or parts other embodiments. Additionally, the components and/or devices may be distributed geographically in addition to physically.

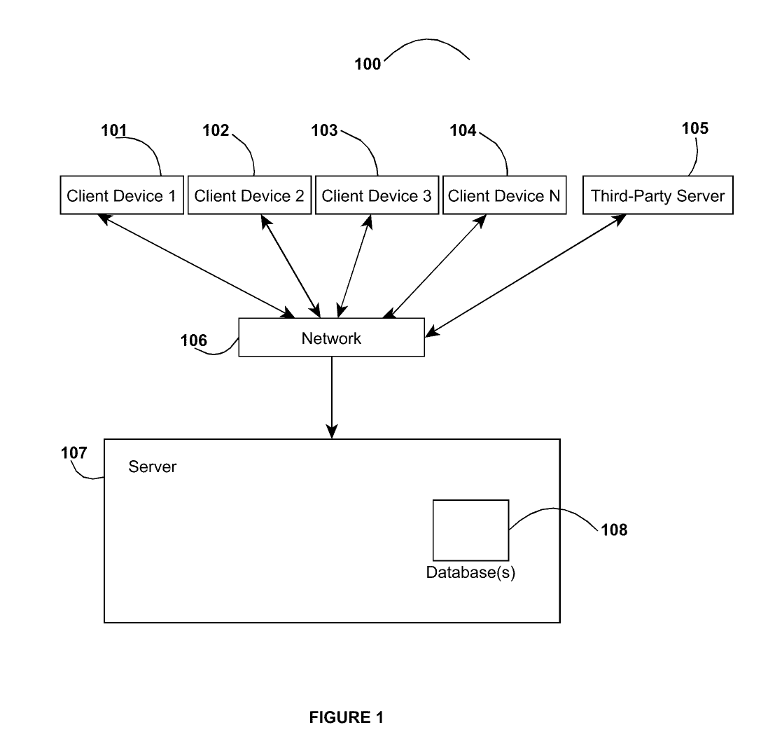

FIG. 1 illustrates, according to one embodiment, a system 100 that includes a server 107 which receives one or more job openings (e.g., full-time, part-time, contract, internship, salaried, hourly, fixed fee, etc.) over a network 106 (e.g., Internet, local network, etc.) from a first job seeker using one or more client devices 101-104 (e.g., cell phone, mobile devices, desktop computer, personal digital assistant (e.g., blackberry), laptop, tablet computer (e.g., iPad), folding device (e.g., folding LCD), kiosk, social network, set top terminals, hand held devices, TV, etc.) and/or from a third-party server 105. Server 107 also comprises database(s) 108. In one embodiment, as discussed above, the client device is a general purpose computer containing a processor, storage devices, inputs/outputs, and bus(es) for communications. For example, the computer could be a 3.0 GHz Pentium 4 with 1024 MB of RAM, 750 GB of hard drive storage and an Ethernet connection.

The client devices 101-104 could provide an infinite number of ways (e.g., website; stand alone applications; applications (e.g., job sharing application on a mobile device, etc.); applet; cloud-computing; social network; friends network; friends account; professional network; groups; network; followers of a person; etc.) to provide the first job seeker one or more job openings.

In one embodiment, the system 100 could display the one or more job openings from the first job seeker. In another embodiment, the system 100 could receive action(s) (e.g., navigating, selecting, viewing, browsing, hovering, responding, etc.) from a second job seeker using a client device 102 and/or from a third-party server 105 with regard to the one or more job openings of the first job seeker. Two job seekers are used as an example, but of course, an infinite number of job seekers and/or client devices could be used and could be distributed around the world.

The same interaction between the first and second job seeker above regarding job openings and the entire discussion below (e.g., the infinite number of different embodiments) could be applied to other job related information: job leads (e.g., information on potential jobs); cover letters; resumes; career advice; interview advice; after-interview analysis (e.g., determine if the interview went well by analyzing questions and answers); human capital movement (e.g., people moving from one job to another); education; other job seekers; third-parties (e.g., consultants, etc.); transcripts (e.g., academic); submitting applications; dressing for the interview; views on employers (e.g., insider views); career and/or work experience; skills necessary for a job opening and/or career; application letters for school (e.g., MBA school); etc. or anything related to the job seeking process. For example, the system 100 could receive one or more cover letters from a job seeker, where another job seeker could access it and use the information to develop and/or modify a cover letter. As another example, the system 100 could receive views and/or opinions and/or thoughts on an employer which could be used by a second job seeker to evaluate a prospective employer. In another example, career experience and/or skills could be shared which could assist a job seeker to understand the requirements, for example, for a particular job opening. In another example, human capital movement could be shared, where a second job seeker could access information by a first job seeker about movement of individuals from one company to another company. Of note, this paragraph saves from repeating every paragraph above and below with regard to each piece of the job related information. The forgoing could, of course, be applied to other person and/or entity (e.g., employers, employees of employers, people employed who seek to obtain benefits for providing job openings, entities, etc.) for one or more job openings and/or job related information.

The one or more job openings of the first job seeker could be made up of job openings that the first job seeker believes are open based on information received from another source. This source could be from networking contacts (e.g., friends, family, former and/or current co-workers, colleagues in the field, classmates, consultants, general contacts, etc.); Internet research; employers; and/or message alerts; etc. There are several reasons (alone or in combination) why a first job seeker could provide his or her one or more job openings.

First, in one embodiment, the one or more job openings of the first job seeker could comprise job openings that the first job seeker submitted an application to an employer, but the employer rejected (and/or did not proceed with) the first job seeker. In this situation, the first job seeker is ensured he or she is not competing for the same job openings with other job seekers (and/or other persons and/or entities). Thus, by several job seekers providing job openings they are aware of, but were rejected from, the system 100 could contain a pool of jobs available for other job seekers to review and submit an application.

Second, in one embodiment, the system 100 could provide the first job seeker with financial and/or some other benefits and/or rewards for the one or more job openings of the first job seeker. For example, if the second job seeker obtains employment using the first job seeker one or more job openings, then the first job seeker could receive benefits. These benefits could be, for instance, in combination or alone, money; points (e.g., purchase products on another site, receive money after a certain number of points, etc.); provided job openings and/or job leads (discussed below); entered into a draw for a prize; enhanced reputation (or good-will) scale; etc. The job openings and/or job leads discussed could be provided, exclusively and/or semi-exclusively (with a small number of others) based on the first job seeker's profile (and/or any document(s) in the Application discussed below (e.g., resume and/or cover letter, etc.), etc.). Also, in combination or alone, the first job seeker's reputation scale could be increased or decreased depending on the number of job openings provided.

Third, in one embodiment, the first job seeker could provide some or all available job openings because the first job seeker is working together in a group with other similarly situated job seekers (and/or persons and/or entities). This group works together to support its members in finding a job. It is similar to in school where various students form study groups to prepare for a test. The students study together for the same test by taking practice question, but each student takes the test individually. Similarly, by working together with other job seekers to find a job, each job seeker could be better prepared to find a job and eventually for the interview (or test).

Fourth, in one embodiment, the first job seeker could provide some or all available job openings because the first job seeker wants to see someone else find a job (e.g. good human nature or “the right thing to do”). Also, the first job seeker could believe that all forms of job searching should be free.

Fifth, in one embodiment, the first job seeker could provide some or all available job openings because the first job seeker is bartering (and/or trading and/or exchanging and/or negotiating and/or swapping and/or haggling and/or switching and/or changing and/or selling and/or lending and/or securitizing) job openings with another job seeker (and/or persons and/or entities). In another embodiment, the first job seeker could receive job openings from a second job seeker in exchange for providing job openings to the second job seeker.

Sixth, in one embodiment, the first job seeker could provide some or all available job openings because the first job seeker is involved in a stock market type arrangement, where the first job seeker one or more job openings could be traded (e.g., price assigned to job openings, shares for each job opening, etc.) on an open market by other job seekers (and/or persons and/or entities). The second job seeker could use any of the benefits discussed above to conduct the trading, such as money; points (e.g., purchase products on another site, money, etc.); job openings and/or job leads; entered into a draw for a prize; reputation scale; etc.

Seventh, in one embodiment, the first job seeker could provide some or all available job openings because the first job seeker one or more job openings are placed in a bidding exchange and/or auctioning arrangement, where other job seekers (and/or persons/entities) bid on the openings. The second job seeker could use any of the benefits discussed above to conduct the bidding, such as money; points (e.g., purchase products on another site, money, etc.); job openings and/or job leads; entered into a draw for a prize; reputation scale; etc.

In addition to receiving the one or more job openings of the first job seeker, the system 100 in one embodiment could also receive, in combination or alone one or more job openings from other person and/or entity (e.g., employers, employees of employers, people employed who seek to obtain benefits for providing job openings, entities, etc.). The other person and/or entity may provide one or more job openings to obtain incentives and/or for other non-incentive reasons, which were both discussed above.

In one embodiment, the system 100 could contact (e.g., e-mail, phone, etc.) employers, who are listed on the one or more job openings received, to determine if they have any additional job openings. Additionally, in combination or alone with the forgoing in one embodiment, the Internet could be searched using an algorithm to find additional job openings matching certain job categories. Further, in combination or alone with any of the forgoing in one embodiment, the system 100 could seek to be included on employer e-mail lists announcing new job openings.

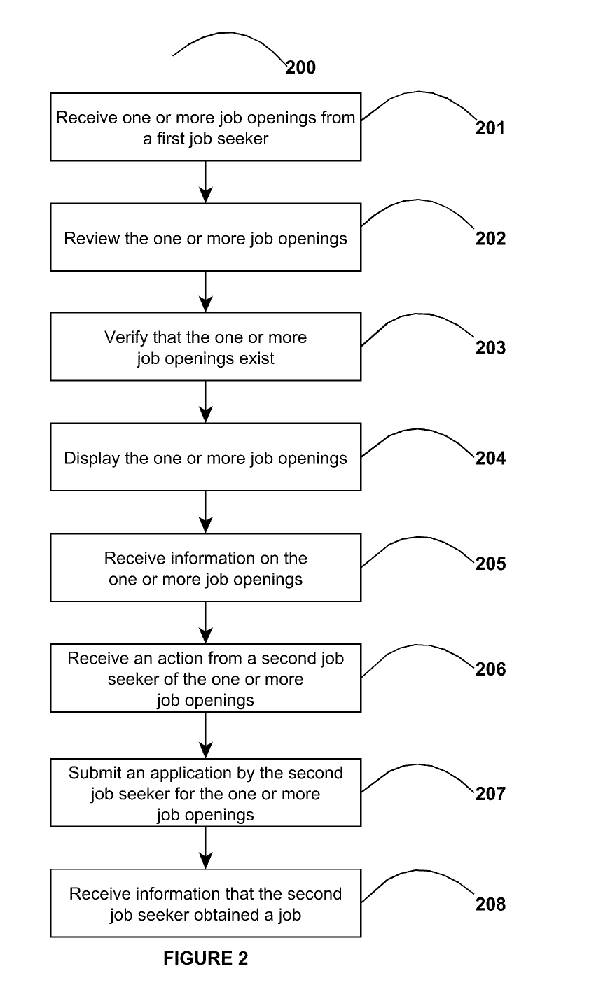

FIG. 2 illustrates, according to one embodiment, a block diagram outlining a method 200 for sharing one or more job openings. Method 200 could be performed in the context of system 100.

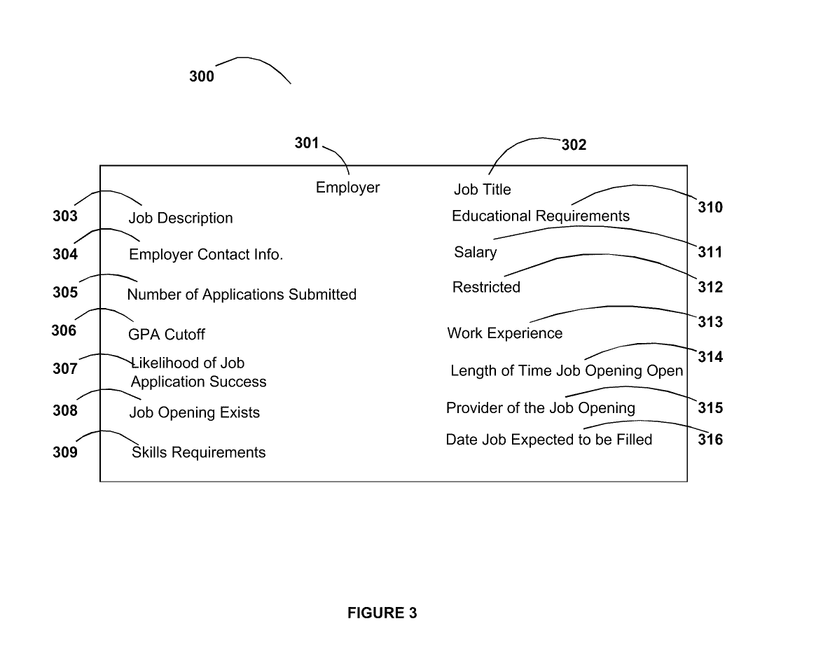

According to one embodiment, in step 201, one or more job openings are received from a first job seeker. In one embodiment, at step 202 the one or more job openings from the first job seeker 201 could be reviewed, that is, determine whether the one or more job openings from the first job seeker 201 should be removed and/or filtered and/or not shown and/or highlighted and/or requested further information and/or transmitted and/or revised, etc. For example, step 202 may determine that one or more of the 22 pieces of information discussed further below in reference to FIG. 3 related to the one or more job openings from the first job seeker 201 is not complete and/or ambiguous and/or duplicate and/or similar to other job openings and/or inaccurate and/or thereby request further information. For example, it may be determined that the information supplied with the one or more job openings from the first job seeker 201 is not appropriate and/or remove it completely. In another example, step 202 may highlight certain information that is important, such as deadline for the one or more job openings from the first job seeker 201. In another example, a message could be sent to the job seeker requesting revised job openings. In another example, the one or more job openings from the first job seeker 201 could be associated with related job openings. In another example, step 202 may transmit the one or more job openings from the first job seeker 201 to certain one or more job seekers and thereby provide a VIP (or first-class) preference. In another example, step 202 may transmit the one or more job openings from the first job seeker 201 to one or more job seekers whose profile (and/or any document(s) in the Application discussed below (e.g., resume and/or cover letter, etc.), etc.) match the one or more job openings from the first job seeker 201.

After receiving and/or reviewing the one or more job openings from the first job seeker 201, the first job seeker one or more job openings 201 in one embodiment could be verified in step 203 to ensure that the one or more job openings from the first job seeker 201 actually exist as this avoids the second job seeker from inquiring about job openings that do not exist. The verification could be performed in a number of ways, alone or in combination.

In one embodiment, the Internet could be searched for the one or more job openings from the first job seeker 201 to confirm its availability and/or through manual human searching and/or using an algorithm, which could return a weight and/or percentage and/or scale and/or integer, words, fuzzy logic (e.g., likely available, possibly available etc.), etc. indicating the likelihood that the one or more job openings from the first job seeker 201 exist. In another embodiment, the algorithm could be a function of one or more of the sources that the one or more job openings from the first job seeker 201 exist. For example, Function_{Job Opening Exists}=(e.g., Internet searching and/or manual searching and/or potential employer providing information on the one or more job openings from the first job seeker 201 (e.g., send message to employer inquiring about the job opening, obtain information directly from employer's website, etc.) and/or employee of the potential employer providing information on the one or more job openings from the first job seeker 201 and/or other job seekers providing information on the one or more job openings from the first job seeker 201 and/or networking contacts providing information on the one or more job openings from the first job seeker 201, etc.).

Also, in one embodiment, one or more job seekers could vote on whether the one or more job openings from the first job seeker 201 exist. Additionally, in another embodiment, a committee of job seekers could be responsible for verifying whether the one or more job openings from the first job seeker 201 exist (e.g., this could take the form of groups of job seekers). As discussed above, in another embodiment, a weight could be returned indicating the likelihood that the one or more job openings from the first job seeker 201 exist. In another embodiment, if a job seeker applies and receives a response from the employer, he or she could report whether the one or more job openings from the first job seeker 201 actually exist.

In one embodiment, the job openings shown to the second job seeker could be those that have a likelihood that the job opening exists greater than a threshold, cutoff, weight, etc. value and/or greater than a certain statistical confidence interval. In another embodiment, the threshold value could be set, for example, by an administrator, an algorithm, based on data from the Internet (e.g., search engines), and/or from statistical data (e.g., bell curve). In another embodiment, the job openings and the corresponding assigned weight could be provided to the second job seeker so he or she knows which jobs are more likely available.

In another embodiment, rather than the second job seeker viewing only those job openings which pass a certain threshold, the second job seeker could receive all available job openings in the form of a confidence interval graph, weighted graph, and/or the job openings with the weight assigned to each opening beside it indicating the likelihood that the job opening exists (e.g., no filtering as discussed above).

According to another embodiment, the job openings could be provided without showing the likelihood that each job opening exists (e.g., just show the job openings without performing any type of verification).

According to another embodiment, alone or in combination, the verification of the one or more job openings from the first job seeker 201 could also include verifying any information associated with the one or more job openings, including any of 22 pieces of information discussed in reference to FIG. 3 below.

In one embodiment, in step 204 could display the one or more job openings from the first job seeker 201. In step 205, further (and/or augmenting) information could be received from a third job seeker on the one or more job openings from the first job seeker 201 and/or information in general not related to the one or more job openings. For example, the information could be: related to the employer (e.g., “Company X is a great employer”, interview suggestions for the particular employer, provide links to one or more other job seekers who use to or currently work at the particular employer, etc.); recommendations for other job seekers (e.g., “job seeker X is great employee”); links to one or more job openings; and/or information (e.g., recommendations) on third-parties, such as coaches, counselors, etc.

In one embodiment, any information provided by the third-job seeker could be verified (as discussed above) to ensure its accuracy. If the second job seeker obtains a job, the third-job seeker could also be provided with money; points (e.g., purchase products on another site, money, etc.); job openings and/or job leads; entered into a draw for a prize; reputation scale; etc.

In one embodiment, in step 206, action(s) (e.g., navigating, selecting, viewing, browsing, hovering, responding, etc.) are received from a second job seeker and/or from a third-party server with regard to the one or more job openings from the first job seeker 201.

According to another embodiment, in step 207, documents could be submitted for a second job seeker for the one or more job openings from the first job seeker 201. Cover letter; and/or resume; and/or curriculum vitae; and/or work authorization; and/or academic transcript (e.g., high school, undergraduate, master's, PHD, law, medical, business school, dentistry school, etc.); and/or test scores (e.g., LSAT, GMAT, MCAT, SAT, etc.); and/or portfolios; and/or list of courses taken with or without corresponding descriptions; and/or certifications; and/or references; and/or writing sample; and/or letters of recommendations; and/or references; and/or certificates; and/or answers to employer asked questions; and/or method 200 (and/or system 100) asked questions, etc. (individually or collectively, the “Application” or the “Job Application”) could be received from a second job seeker. For example, an Application could consist of one or more the forgoing, such as a resume. In another example, an Application could consist of a transcript and portfolios. Numerous different arrangements are possible as an Application based on the number of different possible items within an Application.

In one embodiment, in step 208, once the second job seeker obtains a job, information could be received (e.g., through a message, receiving a box selection beside the job opening obtained, etc.) indicating that the second job seeker obtained a job. The second job seeker may want to inform the method 200 once securing a job for any one or in combination of the following reasons. First, the second job seeker could have agreed to it as part of the original sign-up process. Second, the second job seeker could receive benefits (similar as discussed above). Third, the second job seeker may want to ensure (or “do the right thing”) that other job seekers are not applying for job openings that are not available.

In one embodiment, even if the second job seeker does not inform the method 200, it could be determined through other ways that the second job seeker has the job. In another embodiment, the employer who hired the second job seeker could receive a message (and/or call) asking whether the job opening is filled. In another embodiment, information could be received from other job seekers in exchange for receiving benefits, for example. In another embodiment, the employer's website could be searched to determine if a new employee appears. This in turn could cause the job opening to be removed to ensure that other job seekers are not reviewing a job opening that has already been filled. Also, in another embodiment, once the job opening is filled, this could enable the first job seeker to obtain benefits (as discussed above) for providing the one or more job openings which resulted in the second job seeker (and others) obtaining a job.

FIG. 3 illustrates, according to one embodiment, a system 300 showing one or more job openings. In another embodiment, the second job seeker (along with infinite number of job seekers) could view the job openings through a system 300 (which received the job openings) from a first job seeker. This system 300 could display the job openings with one or more of the following information:
1. the employer 301 (and/or one or more of the 36 employer characteristics discussed further below);
2. title of the job opening 302;
3. job description 303;
4. contact information for the employer 304 (e.g., a person and/or general company information);
5. number of applications submitted 305 (e.g., this provides the job seeker with an idea of the competition regarding the job openings);
6. grade point average cutoff 306 and/or other test scores (e.g., LSAT, GMAT, MCAT, SAT, etc.) and/or grades for certain classes and/or types of classes;
7. likelihood of job application success 307 (explained further below);
8. a weight assigned to the job opening indicating the likelihood that the job opening exists 308 as discussed above, etc.
9. skills requirement 309 (e.g., programmer in certain languages, etc.);
10. educational requirements 310 (e.g., undergraduate and/or college degree, master, PhD and/or type of school and/or certain rankings of school, such as Ivy League school and/or Top 20 law school and/or Top 20 business school, etc.);
11. salary 311;
12. restricted 312 (e.g., only those people who meet certain criteria could apply; discussed more fully below)
13. work-experience requirements 313 (e.g., 10 years experience in marketing, technical degree required, etc.);
14. length of time the job opening has been open 314;
15. who and/or it provided the job opening 315 (e.g., first job seeker);
16. date when the job is expected to be filled 316 (e.g., this provides the job seeker with an idea of when an application would have to be submitted);
17. related job openings (e.g., other job openings that the job seeker may be interested in viewing) (not shown in FIG. 3);
18. job type (e.g., full-time, part-time, contract, internship, salaried, hourly, fixed fee, etc.) (not shown in FIG. 3);
19. location (not shown in FIG. 3);
20. responsibilities (not shown in FIG. 3);
21. related articles (not shown in FIG. 3); and/or
22. past job openings viewed by the job seeker and/or recently viewed job openings by other job seekers (not shown in FIG. 3).

In one embodiment, one or more of the above 22 pieces of information could be received from the job seeker when he and/or she provides the one or more job openings to the system 300. This information could be entered using any type of control (e.g., checkbox, button, dropdown menu, textboxes, etc.) In another embodiment, the job seeker could enter any information regarding the one or more job openings and the system 300 could then parse (and/or extract) information from it to develop the one or more of the above 22 pieces of information above. In another embodiment, a map could be displayed showing one or more job openings and/or one or more related job openings and/or any one or more of the above 22 pieces of information. The map is helpful as, for example, it allows job seekers to view one or more job openings in other cities and/or states and/or countries.

In one embodiment, the system 300 could search for any one or more of the above 22 pieces of information above by using the Internet. In another embodiment, the system 300 could receive information from other job seekers and/or individuals and/or entities for any one or more of the above 22 pieces of information above. In another embodiment, they could receive benefits (as discussed previously) for providing that information.

According to one embodiment, the system 300 could allow all job seekers to have a profile with a list of all job openings of interest. This could include job openings obtained from websites and thus include jobs provided by employers (and/or employees). In another embodiment, the profile could store any one or more of the above 22 pieces of information specific to the job seeker and other information, such as age or date of birth, ethnicity, salary history, job opening sought, length of time searching, networking contacts, etc. and/or other uploaded information (e.g., any document(s) in the Application discussed above (e.g., resume and/or cover letter, etc.), etc.). In another embodiment, the profile could be used to determine a likelihood of success for a job opening by matching one or more of the above 22 pieces of information to the profile and/or other uploaded information (e.g., any document(s) in the Application discussed above (e.g., resume and/or cover letter, etc.), etc.).

According to one embodiment, the job openings could be listed with a restricted status, meaning only those job seekers who meet certain criteria for the job opening could apply and thus possibly limit the number of applications that employers have to review. The system 300 in another embodiment could analyze the job seeker's profile and/or other uploaded information (e.g., any document(s) in the Application discussed above (e.g., resume and/or cover letter, etc.), etc.) to any one or more of the 22 pieces of information above to determine if the job seeker meets the job opening criteria and thus allowed to apply.

In one embodiment, suggestions could be provided that could allow the job seeker to meet the job opening criteria. In another embodiment, the job seeker could seek reconsideration from the system 300, where the system 300 could recalculate if the job seeker meets the job opening criteria. For example, this reconsideration could include information (e.g., submitting a message, uploading a document, filling out an online form, revising a profile, etc.) which shows how the job seeker meets the criteria and/or that an error occurred by the system 300 and/or by the job seeker. In another embodiment, the system 300 could receive and use control data (e.g., checkbox, button, dropdown menu, textboxes, etc.) and/or automatically perform the analysis discussed above to determine if the job seeker meets the job opening criteria. In another embodiment, the system 300 could continuously (and/or actively) and/or at any type of interval perform the analysis discussed above to determine if the job seeker meets the job opening criteria.

According to another embodiment, the system 300 could allow job seekers to perform searches within the system 300, for example, by: employer; location (e.g., city/state/zip (or postal) code); cutoff grade point average; field (e.g., investment banking); sub-field (e.g., M&A); category of the search (e.g., part-time, contract, full-time, salaried job, teen, entry job, intermediate job, advanced job (e.g., PhD necessary)), etc. to find available job openings faster. In another embodiment, the search could be performed using any one or more of the above 22 pieces of information.

In another embodiment, the system 300 could allow job seekers to interact in different languages thereby facilitating world-wide searching. Job seekers could correspond in different languages and this correspondence could be translated to allow others to view those jobs in other countries.

According to another embodiment, the system 300 could include an area where job seekers could ask questions and job seekers or third-parties (e.g., consultants, counselors, coaches, employer, employees, or any person/entity related to the job seeking process, etc.) provide answers. This generates information on which future job seekers could analyze to determine the proper path to find a job opening. The third-parties could provide this information likely to obtain future business and/or work. For example, by answering a question(s), the third-party may be contacted and/or hired to provide further advice. Further, once the job seeker obtains a job, he or she can recommend and/or provide positive feedback regarding the third-party, which in turn could provide further opportunities for the third-party.

In one embodiment, the system 300 could provide a third-parties' area in conjunction or alone from the job seekers' question/answer area. In the third-parties' area, there could be a ranking of the third-parties based on voting and/or weighting of job seekers and/or an algorithm. The algorithm could be a function of: recommendations of third-parties from job seekers and/or from recommendations of other third-parties and/or known in the marketplace and/or skills and/or satisfactory answers to questions discussed previously and/or language abilities (e.g., can interact in a number of languages) and/or costs of services (and/or goods) and/or time to provide services (and/or goods), etc. In conjunction with or alone with the ranking, these third-parties could start groups like the ones discussed later where they could interact.

In one embodiment, the system 300 could provide an interview area for past and/or potential interviews. Many times after an interview the person that was interviewed may like to analyze how he or she performed. Additionally, he or she may want to know how to draft a thank you message to the interviewers and/or the meaning of certain verbal and/or non-verbal events and/or actions and/or cues during and/or after the interview. In another embodiment, the system 300 could receive job seeker's questions and/or answers which occurred during an interview. Another job seeker could provide information (e.g., positives and/or negatives) regarding the questions and/or answers. For example, that another job seeker could state why certain questions were answered well along with suggesting improvements.

In another embodiment, the system 300 could receive statements (e.g., an interviewer stated certain concerns, etc.) made (e.g., by the interviewer and/or interviewee) during the interview. Another job seeker could provide information (e.g., positives and/or negatives) regarding those statements. In another embodiment, the system 300 could receive events and/or actions (e.g., the interviewer took a phone call during the interview, the interviewer did not respond to a thank you message sent to him or her, etc.) and/or cues and another job seeker could provide advice as to the meaning of those events and/or actions and/or cues.

According to one embodiment, potential interview questions and/or answers could be received. The system 300 could receive questions and/or answers to past (and/or present and/or future) interview questions and other job seekers could use this information to prepare for any future interview. For example, the system 300 could receive interview questions and/or answers from a job seeker, where another job seeker could review them and/or provide further information on the questions and/or answers. In another example, a job seeker could provide sample questions and answers given for a particular interviewer (e.g., entity and/or person) and/or potential employer. This could allow other job seekers to better prepare for the same interviewer and/or potential employer.

According to another embodiment, the job seekers could subscribe to receive daily, weekly, and/or yearly messages (e.g., e-mails, etc.), where the messages could comprise one or more job openings available with information about the job openings such as any one or more of the 22 pieces of information discussed above. These messages could be based on matching any one or more of the 22 pieces of information discussed above and/or other uploaded information (e.g., any document(s) in the Application discussed above (e.g., resume and/or cover letter, etc.), etc.) as compared to the profile of the job seekers and then send messages to those job seekers advising of potential available job openings. These messages could allow job seekers to learn about job openings without even performing any proactive searching.

In one embodiment, each job seeker could have a username and password to ensure only truly active job seekers are using the system 300. Also, in another embodiment, the job seeker could be asked to select a box indicating that the job seeker is accessing the job openings as a job seeker and not to later sell and/or use the information for commercial purposes. The username and password could also protect job seekers identity to ensure they can search for job openings without worry that their current employer and/or someone else could know.

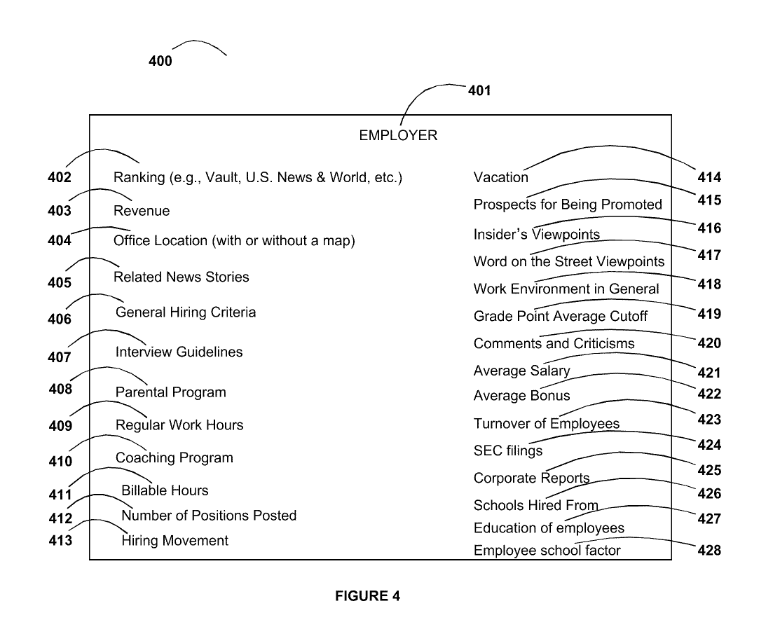

FIG. 4 illustrates, according to one embodiment, a system 400 showing employer related information for job openings. According to another embodiment, the second job seeker could perform some action (e.g., navigating, selecting, viewing, browsing, hovering, responding, etc.) related to the employer causing the system 400 to display (e.g., in the form of a pop-up, roll-over message, right-hand side of the window, opening a new page, video, sound, combination of any of the forgoing, etc.) employer characteristics with one or more of the following shown below. (In another embodiment, one or more of the employer characteristics below could be shown with the one or more job openings without the job seeker performing any action.)
1. employer name 401
2. employer ranking 402 (e.g., Vault, U.S. News & World, etc.);
3. revenue 403;
4. office location(s) 404 (e.g., map, text, etc.);
5. related news stories 405;
6. general hiring criteria 406 (e.g., top ten school, good personality, etc.);
7. interview guidelines 407;
8. parental programs 408 (e.g., two weeks leave to take care of a baby);
9. work hours 409 (e.g., 8:30-6:00);
10. coaching and/or mentoring program 410;
11. billable hours 411 (e.g., number of hours required to be billed to a client);
12. number of job openings available and/or posted 412 (could be divided in category of job openings, location, etc.);
13. hiring movement 413 (discussed below);
14. vacation time 414;
15. prospects for being promoted 415;
16. insider's viewpoints 416 (e.g., what a current and/or former employee thinks);
17. word on the street viewpoints 417 (e.g., what people have heard about the employer) and/or general reputation;
18. work environment in general 418 and/or culture (e.g., very professional and friendly; long-hours and friendly environment; 9-5 position with expected contributions to company events, etc.)
19. grade point average cutoff 419;
20. comments and criticisms from others 420 (e.g., rating sites, blogs, social media, generally through the Internet, and/or in-person, etc.);
21. average salary 421 (e.g., per position type, per group, etc.; this could also be translated into words, such as generally pays well, etc.);
22. average bonus 422 (e.g., per position type, per group, etc. this could also be translated into words, such as medium bonus, etc.);
23. turnover of employees 423 and/or volatility factor (e.g., numeric rating and/or text outlining the likeliness that an employee will leave) and/or attrition rate;
24. SEC filings 424 (e.g., 10-K);
25. corporate reports 425 (e.g., annual, bi-yearly, etc.) from the employer;
26. schools the employer hires from 426;
27. a list of employees and their education 427 (e.g., degrees);
28. an employee school factor 428 (discussed below) and/or prestige factor, etc.;
29. retirement programs (not shown in FIG. 4);
30. related articles (not shown in FIG. 4);
31. related job openings (not shown in FIG. 4);
32. size of the company (not shown in FIG. 4);
33. challenging and interesting work (not shown in FIG. 4);
34. mentoring programs (not shown in FIG. 4);
35. future direction of the employer (not shown in FIG. 4); and/or
36. employer leadership (not shown in FIG. 4).

Generally, the information related to the employer could assist the job seeker to make a well-advised decision before applying for certain job openings. It is not uncommon for a job seeker to become excited about a job opening, but only to learn after applying, for example, that the salary is below market and/or the work-environment does not meet the job seeker's expectations.

According to one embodiment, the list of employees with degrees could be used to calculate an employee school factor, that is, a score could be determined based on where each employee went to school (e.g., graduate and/or undergraduate and/or college). This information could be obtained from school ranking sites (e.g., U.S. News & World) and/or other websites. Using this information, the job seeker could better identify potential employers that match the job seeker's credentials. For example, if a company generally has employees graduating from schools, such as New York University and University of Chicago for undergraduate and Harvard and Columbia for graduate, then the school factor could likely be high. In another embodiment, the school factor could also be calculated from the class status (or how high the employee graduated in his or her class) alone or in combination with the schools discussed previously. For example, in the class status alone calculation (without considering the schools), someone who graduated magna cum laude and cum laude from the undergraduate and graduate school, respectively, could likely have a higher school factor than someone who graduated with no specific class status from his or her undergraduate and graduate institution. In another embodiment, a combination of class status with schools could be used to calculate the school factor. For example, someone who graduated cum laude and cum laude from Harvard and Harvard law school could likely have a school factor that is high.

In one embodiment, an algorithm could search the Internet to determine, for example, if a company has had any recent hires. Searching the Internet could comprise analyzing the professional profile of employees and/or social networks to determine if they have switched jobs. In another embodiment, this searching could also (alone or in combination) comprise examining an employer's profile to determine its latest hires. For example, in the legal industry, if a law firm hires a partner, then the firm may need additional attorneys for the partner's anticipated work. In other work environments, the starting of hiring a number of analysts may mean that they are in the process of hiring. The system 400 in another embodiment could convert recent hiring (and/or the lack of hiring) into a percentage, scale, weight, factor, text, etc. and provide it to the job seeker. This could be shown to the job seeker along with further information (e.g., growth, trends, etc.) on the company allowing the job seeker to make a more informed decision.

In one embodiment, the job openings in the system 400 may not list the employer's name (and/or the job seeker's name) to protect their identity. If the employer name is not provided, then many of the information about the employer could still be provided, as discussed above, to allow the job seeker to make an evaluation about the job opening.

According to one embodiment, the system 400 displaying the job openings may interact with an advertising system which could display advertisements based on the profile of the job seeker. In another embodiment, advertisements could also be displayed based on a group's range of profiles. These advertisements could provide advice to a job seeker hoping that in exchange for this advice the job seeker could want to learn more about the advertiser and thus click on links. The advertisements could further be provided in the form of a video, which could be obtained from third-parties' websites. In another embodiment, the advertisements could be a display of third-parties associated with the system 400, such as their profiles illustrating some highlights. In another embodiment, the advertisements could be products and/or services related to the job seeker. In another embodiment, the advertisements could be from the job seekers themselves seeking advice to improve their chances of finding a job.

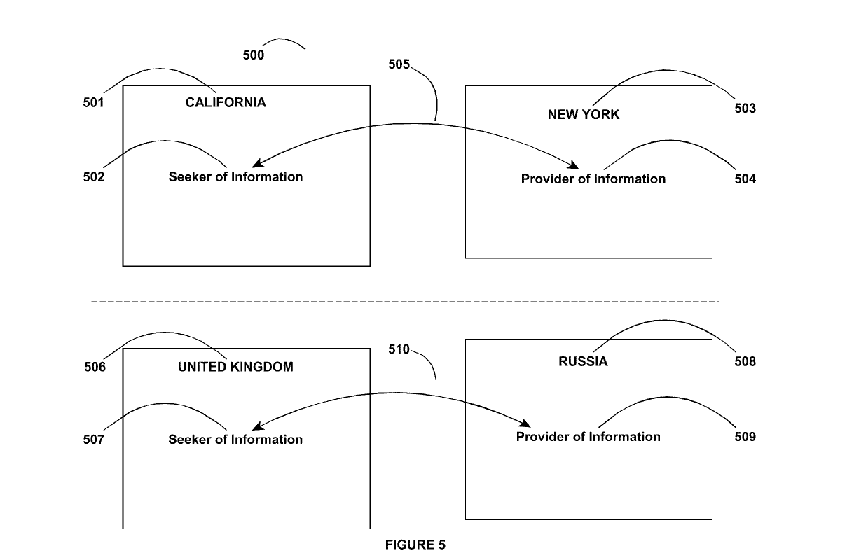

FIG. 5 illustrates, according to one embodiment, a system 500 which shows people interacting across various countries and states. According to another embodiment, the system 500 could allow a person and/or entity 502, 507 to obtain information 505, 510 (e.g., job openings available and/or one or more of the above 22 pieces of information discussed above related to job openings; job environment in a state and/or city and/or at an employer; length of time to find a job; companies hiring; salary information (and/or highest paying employers); types of job openings (e.g., legal, finance, physics, etc.); housing market; areas to live (e.g., safe, costs, etc.); doctors and/or dentists; insurance information; political affiliations; main source of income (e.g., top employers and/or corresponding technology and/or products and/or services); schools; one or more of the 36 employer characteristics discussed above regarding employers; current hiring trend; good places to meet people; a list of other job seekers with similar backgrounds (e.g., skills, age, education, etc.), or any combination of the forgoing, etc.) on (and/or related to) job openings in another country and/or state and/or city and/or county and/or district and/or village, etc from another person and/or entity 504, 509. The exchange of information 505, 510 between the seeker of information 502, 507 and provider of information 504, 509 could occur in both directions, that is, they could have the same roles at the same time so that a person and/or entity could be a seeker and provider of information at the same time and/or the roles could be reversed. In one embodiment, the information could be shown on a map (e.g., job openings shown in various states, related job openings, etc.).

For example, a job seeker 502 in California 501 could find out about the job environment from a person and/or entity 504 in New York 503, without having to travel to New York. Similarly, for example, a job seeker in Australia could find out about the job environment in China or job seeker 507 in United Kingdom 506 could find out about the job environment from a person and/or entity 509 in Russia 508. An infinite number of possible job environment arrangements are possible. Of course the system 500 could allow the job seekers to interact in a number of different languages.

According to another embodiment, any person and/or entity could obtain information on any numbers of things (e.g., purchasing cars; local sports teams to join; buying products; customs; local laws; housing market-houses, apartments, condominiums; places to meet people; restaurants; moving companies; Internet/TV; electric companies; schools; doctors; dentists; lawyers; grocery stores; places to see; good neighborhoods and/or bad neighborhoods; political affiliations; housekeepers and/or nannies; furniture stores; etc.) located in another country and/or state and/or city and/or county and/or district and/or village, etc.

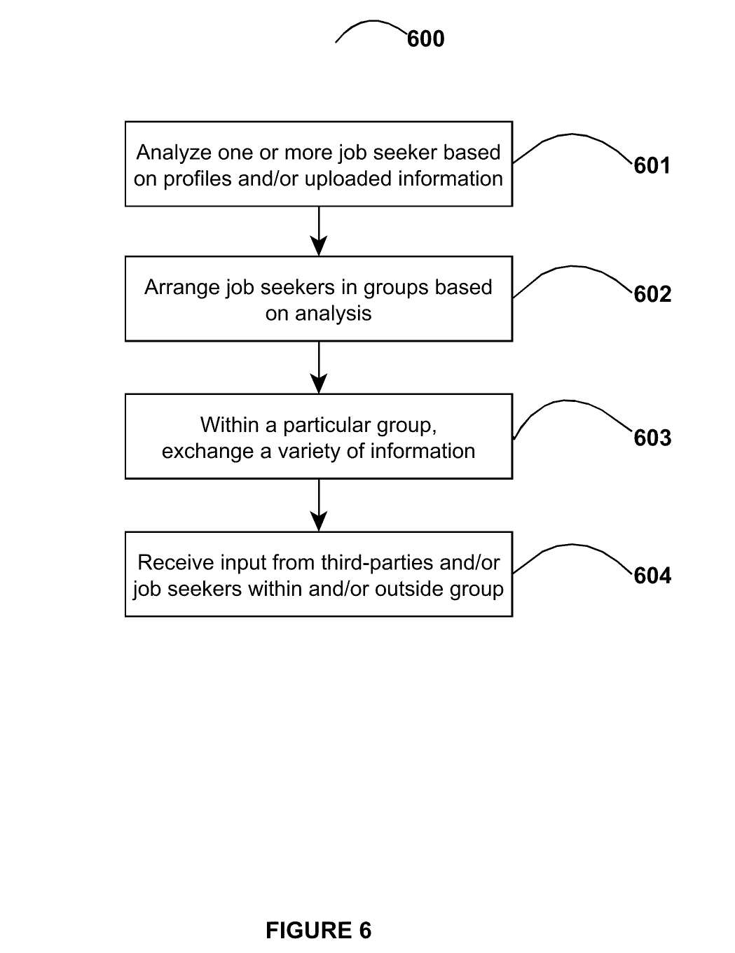

FIG. 6 illustrates, according to one embodiment, a flow chart to create groups. In another embodiment, the system 600 could allow job seekers to create groups thereby facilitating the transfer of job openings between persons who are friends; colleagues; networking contacts; and/or family and/or persons who have similar or same: age; work experience (e.g., people working in a similar field (e.g., consulting, software development, dentistry, law, etc.), same and/or similar previous employer (e.g., former government workers, discharged army/navy personnel, working in the same city and/or state, etc.), etc.); skills; educational background (e.g., graduate of a same or similar (e.g., Ivy league) school, etc.); job search type (e.g., finance, physics, legal, etc.); same type of job opening (e.g., part-time, contract, full-time, salaried job opening, teen job opening, entry job opening, intermediate job opening, advanced job opening, etc.), etc. or any combination of the forgoing. According to one embodiment, job seekers could provide one or more job openings to other members of the group. This could be done by sending the one or more job openings to the group members directly and/or sending them first to a moderator who could then transmit them to the rest of the group. Numerous types of job information could be exchanged in a group.

According to one embodiment, the system 600 could automatically (e.g., through a computer algorithm and/or manual arranging on a computer) create groups based on one or more job seeker's profile and/or other uploaded information 601, 602 (e.g., any document(s) in the Application discussed above (e.g., resume and/or cover letter, etc.), etc.). This could be called dynamic groups. In another embodiment, the system 600 could analyze several job seekers' profile and/or other uploaded information 601 and determine that several job seekers are applying to the same and/or similar job openings and thus arrange them together in a group 602. For example, the system 600 could determine that several job seekers are seeking the same job openings and have a similar age and thus generate a group for those job seekers. An infinite number of groups are possible.

According to another embodiment, the group of job seekers could agree, like a study group in school, to provide everyone with information 603. This information 603 could facilitate the acquisition of a job quicker than, for example, just simply networking. Through the groups more than just jobs could be exchanged. In another embodiment, articles could be shared of interest related to a particular field and/or general job searching techniques. In another embodiment, moral support and job tips could be provided to the others in the group. Also, in another embodiment, cover letters could be reviewed along with resumes. In another embodiment, job seekers could provide advice for other job seekers, such as courses and/or education to improve a job seeker's resume and/or potential available jobs more suitable for the job seekers.

According to one embodiment, job seekers in a group (or job seekers outside a group) could practice their interview techniques in the system 600. A video conferencing system could be setup where the job seekers could all connect to one another. One of job seekers could be the moderator who asks questions to one of the job seekers while the remaining job seekers listen and provide positive and negative feedback regarding the simulated interview. The simulated job interview could be recorded to allow the person being interviewed to review it at a later time to practice his or her interview skills. In another embodiment, the job seekers could provide support for each other by counseling each other. The job seekers could also communicate to one another using video conference, voice over ip, and the like. Further, the system 600 could provide in another embodiment webinars, career videos and the like.

According to one embodiment, job seekers in a group and/or job seekers outside a group could have guess lecturers that provide advice, including the current state of the market (e.g., whether employers are hiring in a particular area); things to improve one's job searching success; general advice; etc.

According to one embodiment, job seekers in a group and/or job seekers outside a group could have third-parties (e.g., another job seeker, coach, counselor, etc.) provide input at step 604. These third-parties could be responsible for providing encouragement to the job seeker along with discussing with the job seeker potential problems, including how to answer certain questions in an interview regarding the job seeker's resume (e.g., interest in a particular area outside the job seeker's specialization, such as moving from physics into engineering). The third-parties could be computer generated and developed using any programming language, such as C, C++, Java, and the like. The third-parties within the system 600 could send the job seeker messages and/or hold conferences where a discussion could take place regarding the future direction of jobs.

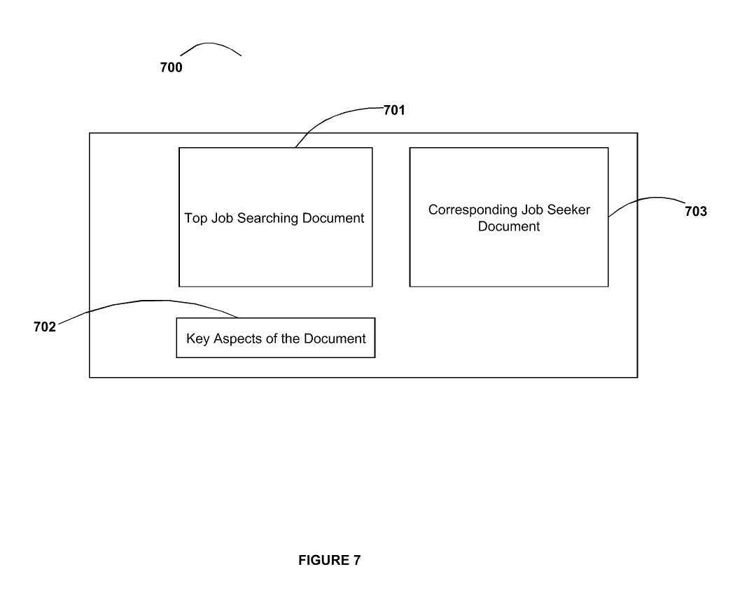

FIG. 7 illustrates, according to one embodiment, a system 700 that could provide a top job searching document 701 (e.g., cover letter; and/or resume; and/or curriculum vitae; and/or work authorization; and/or academic transcript (e.g., high school, undergraduate, master's, PHD, law, medical, business school, dentistry school, etc.); and/or test scores (e.g., LSAT, GMAT, MCAT, SAT, etc.); and/or portfolios; and/or list of courses taken with or without corresponding descriptions; and/or certifications; and/or references; and/or writing sample; and/or thank you letter; and/or interview questions; and/or answers to interview questions; and/or letters of recommendations; and/or references; and/or certificates; and/or answers to employer asked questions; and/or system 700 asked questions, etc.). In another embodiment, the system 700 could provide a top: job seeker and/or employer and/or consultant and/or job searching process and/or group of job searchers, etc. By viewing the top job searching document 701, this could allow other job seekers to improve their own documents and/or provide them with additional information. For example, a job seeker could view a resume considered the best in whatever job searching area. The reason a job seeker may allow his or her resume to be shown by the system 700 as a top resume is to receive benefits (as discussed above), additional feedback, additional suitable job openings, and publicity in the hope of obtaining a job.

According to one embodiment, the system 700 could also show aspects 702 about the job searching document 701 that make it a top document. For example, certain words could be highlighted and/or a description (e.g., text, video, voice, etc.) could be provided.

According to one embodiment, the present job seeker viewing the top job searching document 701 could have his or her corresponding document 703 shown beside and/or below and/or above the top job searching document 701. In another embodiment, the job seeker's corresponding document 703 could be shown how it is different than the top job searching document 701, such as highlighting certain words, providing a description (e.g., text, video, voice, etc.), redline the differences, etc. In another embodiment, the top searching document 701 and the corresponding document 703 of the job seeker could be merged and/or combined in such a way as to add certain characteristics found in the top searching document to the corresponding document 703.

According to another embodiment, the top job searching document 701 could have private information removed, such as name, address, GPA, etc. and replaced with fictitious information and/or removed entirely. In another embodiment, some private information could be shown if the job seeker consented to it either through an agreement signed when creating an account and/or through e-mail, text, and/or other confirmation, such as an e-mail requesting the job seeker click a box to allow the system 700 to show his or her top job searching document 701. (In another embodiment, the job seeker could revoke this consent if he or she decides that the top job searching document 701 should not be shown by the system 700.)

In another embodiment, a map could be shown of top job searching documents 701 in various countries, states, cities, towns, etc. This could allow a job seeker to view a top job searching document 701 in another location and thereby facilitate a transition easier to the job market in that location.

According to another embodiment, the top job searching document 701 could be based on a time period, such as the top job searching document 701 of a day, week, month, year, century, or any time period. The system 700 could further provide a top job searching document 701 based on other characteristics, such as for: a certain profession (e.g., law, medical, dentistry, consulting, finance, teachers, etc.); same or similar current or previous employer; age group (baby boomers, teens, young professionals, more senior, etc.); job seeker defined groups discussed previously; graduates of a same or similar (such as Ivy league) school; working in the same and/or similar city or state; age; background; qualifications, etc.

According to another embodiment, the top job searching document 701 could be determined based on a vote of job seekers within a group and/or job seekers outside a group. Alternatively (and/or together with the vote), in another embodiment, an algorithm could calculate the top job searching document 701 based on any one of or in combination with the following: job applications; downloads of the top job searching document 701; comments by other job seekers regarding the top job searching document 701; discussions; time to find a job; quality analysis of the top job searching document 701; and/or rankings and/or weightings and/or voting; etc.

The quality of the top job searching document 701 could be determined based on, for example, length of the top job searching document 701 compared to experience and/or age of the person; diction choice; number of words per line; active voice v. passive voice; quality of concepts conveyed (and/or substantive analysis) whereby each line is analyzed to determine if the concept conveyed is significant; etc.

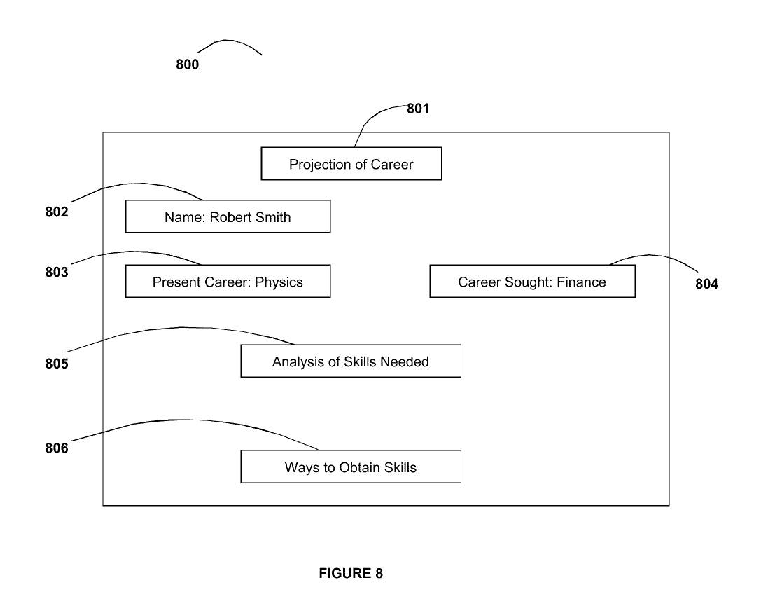

FIG. 8 illustrates, according to one embodiment, a system 800 showing a projection of career. A title 801 could be displayed. The first job seeker may be trained for a certain career, but may like to attain (and/or ascribe to) a different career: a person has been practicing X for a number of years and may like to try something different. In another embodiment, someone 802 who is in physics 803 may wish to enter finance 804 or someone who works on the line in manufacturing may like to own his or her business. The system 800 could provide a projection of the skills and other things 805 necessary to make that transformation to allow each individual person to reach his or her full potential and thus ensure everyone is pursuing his or her dream.

According to another embodiment, the projection of the career functionality could determine what skills (and/or other things) 805 are necessary to attain this new career and where they can be obtained. To determine what new skills are necessary 805, an algorithm could use any number of pieces of information: information contained in the job seeker's profile; other information (e.g., any document(s) in the Application discussed above (e.g., resume and/or cover letter, etc.), etc.); skills entered by the job seeker; current job; new career sought; information obtained from searching the Internet (e.g., job descriptions for the new career, other resumes or information of individuals who hold or previously held the new career, information provided by those in the field of the new career, and/or any general related information, etc.); and information provided by other job seekers, etc. Any number of skills could be suggested and/or provided depending on the current and new career sought by the job seeker.

According to another embodiment, the skills determined to be necessary for the new career could be divided into sections: most competitive in the job market (e.g., these new skills could make the job seeker the most competitive); moderately competitive; and least competitive. Any number of skill category divisions is possible whether by text and/or by using numbers.

In one embodiment, the job seeker could be provided with the best ways 806 to reach this new career. The job seeker could be provided with information, such as: educational requirements; requirements for internships at types of companies (e.g., large investment bank); types of responsibilities required to obtain; grade point average; name recognition of educational provider (e.g., top 20 law school); soft skills (e.g., presentation ability); hard skills (e.g., programming ability), etc. In another embodiment, this could be shown in the form of steps, such as step 1, 2, 3, etc. In another embodiment, this could be shown in the form of a chart (and/or schedule), where the job seeker could view his or her progress and ensure goals are attained. In another embodiment, time information could be provided outlining how long it will take to reach each step and/or portion and/or total time to complete.

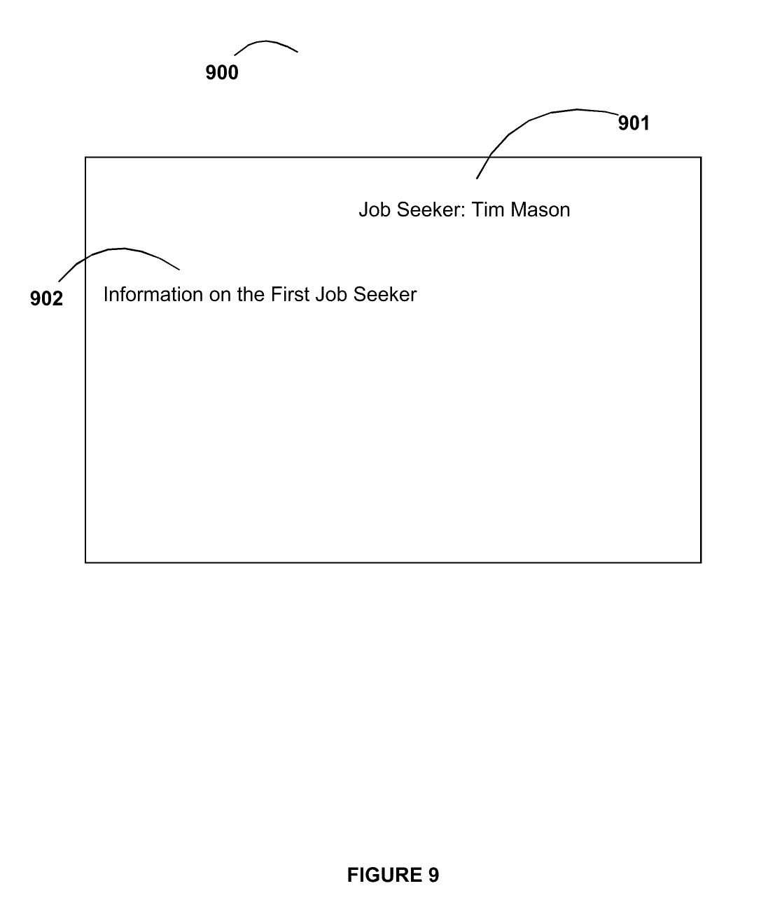

FIG. 9 illustrates, according to one embodiment, a system 900 showing how a second job seeker could step into the shoes and/or the path of a first job seeker. In one embodiment, both the first and second job seeker could be searching for jobs in a same and/or similar field and have the same and/or similar backgrounds. Instead of the second job seeker starting from little initial job searching and/or scratch (e.g., without performing any prior job search work, resume and/or cover letter preparation, etc.), he or she could use the information of the first job seeker 901.

According to another embodiment, a second job seeker could be shown information of the first job seeker 901. This information in another embodiment could include, for example, the available job openings; the profile of the first job seeker; connections made with other people; any document(s) in the Application discussed above (e.g., resume and/or cover letter, etc.); opinions on potential employers (e.g., any of the employer characteristics discussed previously); one or more jobs for which Application(s) were submitted by the first job seeker; current state of the market; employers that have openings; and/or recommended third-parties (e.g., consultants); etc. This information in another embodiment could be shown in the form of a chart, graph, a shoe, weightings, listing, text, etc. The first job seeker could allow the use of the prior information for a variety of reasons discussed previously, such as being provided benefits.

As another example, the path of the first job seeker could be time-based such that the second job seeker could view what the first job seeker did each day and/or week and/or month and/or year, etc. The second job seeker could use the information regarding the first job seeker 901 to obtain a job faster. In another embodiment, the system 900 could use the information regarding the first job seeker 901 to provide suggestions (e.g., job openings; related job seekers; third-parties; job leads; revisions to any document(s) in the Application discussed above (e.g., resume and/or cover letter, etc.), etc.) to the second job seeker.

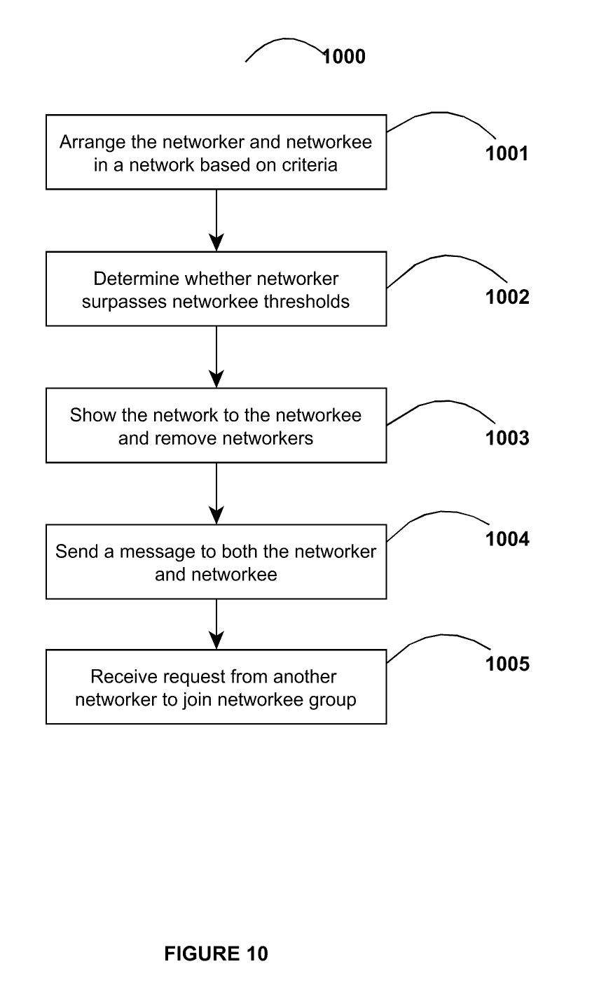

FIG. 10 illustrates, according to one embodiment, a flow chart outlining a networking method. Many employment counselors may recommend networking with people to learn about potential present and future opportunities. The problem being is a person would likely have to know someone (or be introduced by someone) (e.g., a middle-person) to eventually add a desire person as a contact and/or friend. Also, even if a person is added, the person added may not require any of the products and/or services and/or have any information needed of the person. Accordingly, it would be beneficial to have a way to arrange persons together who have similar interests.

A person seeking to network is called the “Networker” and person desired to network with is called the “Networkee”. A Networkee could of course be a Networker at the same time and/or a Networker could be a Networkee. A Networker or Networkee could be any person (e.g., unemployed; employed (e.g., self-employed, by a company, etc.); in school (e.g., elementary school, high school, university and/or college, master, PhD, etc.); conducting research at an academic institution (or hybrid at school/employed); retired, etc.) and/or anything (e.g., entities or companies).

The Networker desires (or has a reason) to network for something: friendship (e.g., meet new people, rekindle lost friendships, etc.); jobs (e.g., find a new job, keep an existing job, unemployed and searching for a job, etc.); romance; business (or revenue) generation and/or business and/or revenue development (e.g., obtain new clients and/or keep existing clients and/or regain lost clients, merge with another company, form partnerships, form joint ventures, start a business, licensing, etc.); and obtain any type of information.

The Networkee also has a reason to network. This could be anything the Networkee needs (e.g., work needed to be performed; an attorney, a marketing campaign, etc.)

According to one embodiment, the system 1000 could automatically (e.g., through a computer algorithm and/or manual arranging on a computer) arrange the Networker and Networkee in networks (e.g., social network, friend network, professional network, internal network, external network, job searching network, etc.) and/or groups based on number of criteria 1001. A Networker and/or Networkee could exist in one or more networks or groups. The criteria, for example, could be: friends; skill set; age; martial status; citizenship; education; same (and/or similar) previous and/or current employers; work experience; international travels (e.g., educational and/or fun); working in the same city (and/or state); income; reputation; revenue; Networker reason for networking as discussed above; Networkee reason for networking as discussed above; general background; geographic location; thresholds (discussed below); sample and/or prior and/or present work product; prior cases and/or matters; qualifications; provide products and/or services in the same/similar field; etc. or any combination of the forgoing.

In one embodiment, at step 1002 the arrangement could be between the Networker and Networkee, where the Networker has met (and/or surpassed) certain benchmarks, cutoffs, thresholds, weights, criteria, etc. (e.g., experience advertising multi-million dollar campaigns, handling over $50 MM litigation, etc.) of the Networkee. In this way the Networkee is not wasting time with non-qualified persons and/or entities by receiving numerous messages.

According to another embodiment, at step 1003 the arrangement of the network could first be shown to the Networkee who (and/or it) could then remove certain persons and/or entities to reach a result set only containing those top or best persons and/or entities in the network that match what the Networkee is seeking. In another embodiment, the Networkee could leave the arrangement of the network alone without removing anyone.

According to another embodiment, at step 1004 the system 1000 could start the communication (and/or break the ice) between the Networker and Networkee by sending a message to both with any combination of the criteria above to show how each other could help one another. In another embodiment, the network arrangement of Networker and Networkee could be sent to each person and/or entity.

According to another embodiment, the Networkee could receive manually and/or through automated algorithm information (e.g., any document(s) in the Application discussed above (e.g., resume and/or cover letter, etc.), introductory and/or summary message, etc.) regarding the Networker. This information could be used to determine if the Networkee wants to proceed with the Networker.

According to another embodiment, at step 1005, it is possible that the Networker may not be placed in the network of the person and/or entity's choosing. The Networker could send a message to the system 1000 requesting to network with certain Netwokee(s). The system 1000 could then determine whether the Networkee is a suitable match. If yes, then in another embodiment the Networkee could receive information (e.g., any document(s) in the Application discussed above (e.g., resume and/or cover letter, etc.), introductory and/or summary message, etc.) regarding the Networker and/or automatically add the Networker to the Networkee's group. If there is no match, then the system 1000 could send back a message stating the criteria that the Networker is missing.

Also, in one embodiment, the system 1000 could send back a message stating the average and/or general background of the person(s) in the Networkee's network and/or group. This message could include any of the criteria discussed above. This could in turn allow the Networker to understand the competition and thus allow the Networker to understand what is needed to attain that network level.

In one embodiment, a description and/or numeric (e.g., ranking, weighting, etc.) could be assigned to the Networker indicating his or her network level. This could be used to understand the general background of that network level as well as determining what is needed to improve one's network level by viewing other Network levels.

In one embodiment, the system 1000 may receive a request from a Networker seeking to understand how certain individuals made the Networkee's network. For example, Networker may feel that the qualifications are not as expected of certain persons and/or entities in the Networkee's network. The system 1000 could analyze the criteria of those individuals to provide information as to why they are in the Networkee's network (e.g., went to the same college; live in the same neighborhood, etc.)

In one embodiment, the Networkee's network and/or group members are kept private so that none of the Networkers know who is connected to the Networkee. The members of the Networkee's group, in another embodiment, could receive a profile of the Networkee's group to allow for further analysis. According to another embodiment, members of the Networkee's network and/or group may not even know they are members until contacted by the Networkee.

According to another embodiment, the system 1000 could provide suggestions based on the criteria discussed above to the Networker(s) of potential Networkee(s) the Networker(s) may be interested in adding to the Networker(s) network and/or contacting. Similarly, the system 1000 could provide suggestions to the Networkee(s) of potential Netwoker(s) the Networkee(s) may be interested in adding to the Networkee(s) network and/or contacting.

FIGS. 1 through 10 are conceptual illustrations used to assist in explaining the claimed invention. It should be understood that various aspects of the embodiments of the claimed invention could be implemented in hardware, firmware, software, or combinations thereof. In such embodiments, the various components and/or steps would be implemented in hardware, firmware, and/or software to perform the functions of the claimed invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “computer readable media” is used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements.

The foregoing description of the specific embodiments so fully reveals the general nature of the invention that others can, by applying knowledge within the skill of the relevant art(s), readily modify and/or adapt for various applications such specific embodiments, without undue experimentation, without departing from the general concept of the present invention. Such adaptations and modifications are therefore intended to be within the meaning and range of equivalents of the disclosed embodiments. Moreover, it is not intended for any term in the specification or claims to be ascribed an uncommon or special meaning unless explicitly set forth as such.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments.

I claim:

1. A computerized method for facilitating employment comprising:
receiving using an electronic device from a first job seeker one or more job openings;
displaying using an electronic device the first job seeker one or more job openings; and
receiving using an electronic device an action from a second job seeker related to the first job seeker one or more job openings.

2. The method according to claim 1, wherein receiving using an electronic device from a first job seeker one or more job openings comprises job openings that the first job seeker was rejected.

3. The method according to claim 1 further comprising submitting using an electronic device from the second job seeker one or more applications for the first job seeker one or more job openings.

4. The method of claim 1, further comprising analyzing information related to the second job seeker; and providing suggestions to a third job seeker based on the analyzed information related to the second job seeker.

5. The method according to claim 1 further comprising awarding benefits to the first job seeker for the second job seeker becoming employed based on the action from the second job seeker related to the first job seeker one or more job openings.

6. The method according to claim 5, wherein the benefits comprise at least one of money, points, job openings, or job leads.

7. The method according to claim 1, further comprising exchanging the first job seeker one or more job openings with a third job seeker one or more job openings.

8. The method according to claim 1, further comprising receiving a communication from the second job seeker that the first job seeker one or more job openings were filled by the second job seeker.

9. The method according to claim 1, further comprising receiving information from a third job seeker on the first job seeker one or more job openings, wherein the third job seeker is provided benefits for providing the further information.

10. The method according to claim 1, wherein displaying using an electronic device the first job seeker one or more job openings comprises one or more job openings that are verified as available.

11. The method according to claim 1, further comprising receiving from a third job seeker one or more job openings.

12. The method according to claim 1, wherein displaying using an electronic device the first job seeker one or more job openings comprises at two of: grade point average cutoff, educational requirements, work experience requirements, number of applications submitted for the one or more job openings, or likelihood of success by the second job seeker.

13. The method according to claim 1, wherein receiving using an electronic device an action from a second job seeker related to the first job seeker one or more job openings comprises viewing an employer associated with the first job seeker one or more job openings; and displaying employer characteristics comprising at least one of: employer ranking, employee school factor, employer revenue, insider viewpoints, turnover of employees over a period of time, or securities and exchange commission filings.

14. The method according to claim 1, further comprising creating one or more groups based on a profile of the second job seeker, wherein the group is related to at least one of educational background, work experience, and job type sought.

15. The method of claim 14, further comprising holding a practice interview session comprising one or more job seekers associated with the one or more groups; recording the interview session; and providing feedback to the one or more job seekers.

16. The method of claim 1, further comprising receiving a past interview question and an answer from a third job seeker; and receiving feedback from a fourth job seeker.

17. The method of claim 1, further comprising receiving a question from a third job seeker; and receiving an answer to the question from one or more third-parties.

18. The method of claim 1, further comprising receiving job information from a third job seeker; determining one or more requirements for the job information; and providing one or more ways to achieve the job information based on the one or more requirements.

19. A system comprising at least one processing device coupled to at least one client device over a network, the at least processing device operable at least to:
receive from a first job seeker one or more job openings;
display the first job seeker one or more job openings; and
receive an action from a second job seeker related to the first job seeker one or more job openings.

20. A non-transitory computer readable media having computer readable program code embodied therein, the computer readable program code when executed by a processing device causes the processing device to perform a method comprising:
receiving from a first job seeker one or more job openings;
displaying the first job seeker one or more job openings; and
receiving an action from a second job seeker related to the first job seeker one or more job openings.
